(19) United States
(12) Patent Application Publication
(10) Pub. No.: US 2011/0302159 A1
(43) Pub. Date: Dec. 8, 2011

(54) COLLEGE SEARCH SYSTEM

(75) Inventors: Brian G. Mikesell, Cincinnati, OH (US); Roger Dooley, Austin, TX (US); Sally Rubenstone, Northampton, MA (US); David E. Berry, Hollidaysburg, PA (US); John Chesher, Edgewood, KY (US)

(73) Assignee: Hobsons, Inc., Cincinnati, OH (US)

(21) Appl. No.: 13/098,580

(22) Filed: May 2, 2011

Related U.S. Application Data
(60) Provisional application No. 61/330,287, filed on Apr. 30, 2010.

(51) Int. Cl. G06F 17/30

(52) U.S. Cl. 707/723; 707/E17.014

(57) ABSTRACT

A method and programmed computing system (12) that enables a college search by matching criteria of a searcher (16) to statistics (14) relevant to colleges. Criteria are compared to stored statistics by a method (30) that scores a college as to at least one specific criterion on a variable scale, such that a college that partially matches the specific criterion is awarded a score that is less than that awarded to a fully matching college but greater than that of a awarded to a less matched college as to the specific criterion. Searchers also provide Boolean criteria for colleges that are incorporated into the college scores. Searchers provide importance weightings for criteria, which are used to weight college scores and create rankings of colleges.

### CROSS-REFERENCE TO RELATED APPLICATION

The present application is related to and claims benefit of U.S. Provisional Application Ser. No. 61/330,287, filed Apr. 30, 2010, the entirety of which is incorporated herein by reference.

### FIELD OF THE INVENTION

The present invention relates to computerized methods and systems for searching for higher education institutions such as undergraduate colleges and junior colleges.

### BACKGROUND OF THE INVENTION

The proliferation of undergraduate institutions has created a challenge for students and parents seeking to be matched with an appropriate institution for their post-secondary school education. Choosing from the wide variety of colleges available to students is made complex by the variation of academic requirements, program depth and ranking, price, size, location, and numerous other factors.

With over 3,000 colleges and universities in the United States alone, the range of choices available to potential applicants is staggering. While some students get bogged down with too many choices, others focus on too few schools, perhaps missing a “perfect fit.” Clearly, there is a need for a method and system that helps students and parents develop a short list of schools that are worth evaluating in detail.

Traditionally, college searches have been conducted using printed guides which include descriptions of schools and rankings or other statistics on their campus attributes. Unfortunately, these printed guides can be time consuming and difficult to use. On-line or computerized tools have been developed, but these tools have often failed to meet the need for college matching, because they use “hard” searching logic. For example, if the user selects a desired School Size range of 7,000-13,000 students, their results list will not contain a school that has 6999 students, even though the school is obviously just as good of a match as a school with 7000 students.

### SUMMARY OF THE INVENTION

The present invention is directed to a method and programmed computing device, that meets this need for enabling effective college searching by parents and students.

The illustrated embodiments of the invention specifically provide a system for searching for colleges matching criteria of a searcher, using storage for statistics relevant to colleges subject to the search, storage for searcher-provided criteria for a search, and a processor which compares stored criteria to stored statistics. The processor scores colleges as to at least one specific criterion on a variable scale, such that a college that partially matches the specific criterion is awarded a score that is less than that awarded to a fully matching college but greater than that of a awarded to a less matched college as to the specific criterion.

In the disclosed specific embodiments, the specific criterion may be a location and colleges matching the location are awarded a full score, whereas colleges in neighboring locations are awarded a partial score. Further, the specific criterion may be available major courses of study, and a college is awarded a partial score computed based upon the percentage of the desired majors that are offered by the college. The specific criterion may also be entrance qualifying scores, and a college is awarded a partial score computed based upon the deviation of the searcher-provided scores from the score ranges of typical students of the college. The specific criterion can also be degree types, and a college is awarded a partial score computed based upon the percentage of degrees offered by the college that match the searcher's desired degree type. The specific criterion may also be student body size, and a college is awarded a partial score computed based upon the extent to which the college is outside of the size range stated by the searcher's criterion. The specific criterion can also be gender mix, and a college is awarded a partial score computed based upon the match of the gender mix of the college to the searcher's desired gender mix. Further, the specific criterion may be admission rate, and a college is awarded a partial score computed based upon the extent of mismatch between the selectivity of the college and the searcher's desired selectivity. Also, the specific criterion may be graduation rate, and a college is awarded a partial score computed based upon the extent of mismatch between the graduation rate of the college and a desired graduation rate. Further, the specific criterion may be sports, and a college is awarded a partial score computed based upon the percentage of sports desired by the searcher which are offered by the college.

In the disclosed specific embodiment, the searcher identifies an importance as to two or more criteria, and the identified importance is used as a weighting factor for scores for colleges in the two or more criteria, the weighted scores being used to rank colleges. More specifically, the searcher identifies the importance using a scale of importance having at least three settings, and the highest setting of importance causes a criterion to be weighted at least ten times more strongly than lower settings of importance.

In the disclosed specific embodiment, the stored criteria also include Boolean criteria such as: public or private status of a college; historically black status of a college; fraternity or sorority activity at a college; religious activity at a college; political leanings of a college; gay, bisexual, lesbian and transgender services at a college; social activity reputation of a college; reputation of the location of a college.

The illustrated embodiments further provide a method of a college search as carried out by the system described above.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a schematic diagram of an embodiment of the invention utilizing a server and remote browser devices;

FIGS. 2A and 2B are schematic diagrams of the data structures utilized by the server illustrated in FIG. 1;

FIGS. 3A, 3B, 3C and 3D are flow charts of the operations performed on the server in response to the selection of college search criteria by a student or parent, and the steps taken to score colleges based on selected criteria.

It should be understood that the appended drawings are not necessarily to scale, presenting a somewhat simplified representation of various preferred features illustrative of the basic principles of the invention. The specific design features of the sequence of operations as disclosed herein, including, for example, specific dimensions, orientations, locations, functions and shapes of various illustrated components, will be determined in part by the particular intended application and use environment. Certain features of the illustrated embodiments may have been enlarged or distorted relative to others to facilitate visualization and clear understanding.

### DETAILED DESCRIPTION

### Hardware and Software Environment

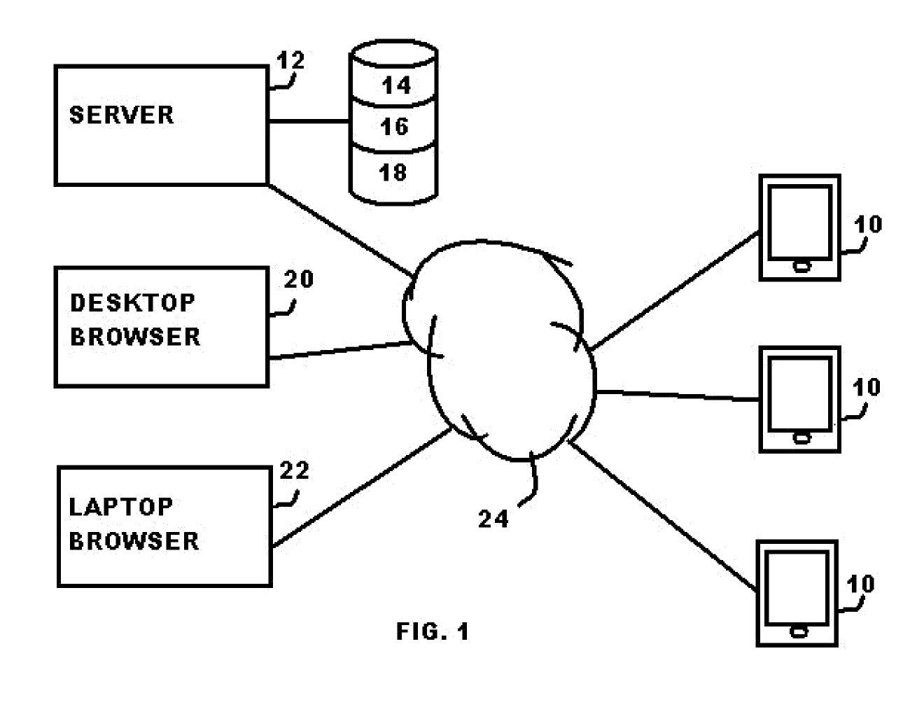

FIG. 1 is a schematic diagram of an embodiment of the invention, illustrating browsing devices in communication with a server to perform college searches using college statistics, personal preferences, and web pages stored in memory.

Turning more particularly to the drawings, wherein like numbers denote like parts through the several views, FIG. 1 generally illustrates a system for college searching in accordance with principles of the present invention, including a server 12 serving data to mobile devices 10 and desktop browsers 20 and 22. Server 12, in specific embodiments, may be a computer, computer system, computing device, server, disk array, or programmable device such as a multi-user computer, a single-user computer, a networked device (including a computer in a cluster configuration), etc. Apparatus 12 may be referred to as “computing apparatus,” but will be referred to as “computing system” for the sake of brevity. In the embodiment of the invention presented herein, the apparatus 10 is in the form of a web server, but this exemplary description is not limiting upon the scope of the principles of the invention, which extend well beyond a particular computing platform.

Computing system 12 may include at least one central processing unit (“CPU”) coupled to a memory. Each CPU may be one or more microprocessors, micro-controllers, field programmable gate arrays, or ASICs, while memory may include random access memory (RAM), dynamic random access memory (DRAM), static random access memory (SRAM), flash memory, and/or another digital storage medium. As such, memory may be considered to include memory storage physically located elsewhere in the computing system, e.g., any cache memory in the at least one CPU, as well as any storage capacity used as a virtual memory, e.g., as stored on a mass storage device, a computer, or another controller coupled to computer through a network interface. Included in memory are school statistics 14, user preferences 16 and web pages 18.

Server 12 is in communication with users of the system on mobile devices 10, each of which may be a palmtop computer, pad computer, mobile phone, a video game console (or other gaming system), in particular including an iOS mobile device such as an iPhone or iPod Touch or iPad or an Android operating system mobile device. Server 12 is further in communication with searchers using desktop browsers on desktop or laptop computer systems 20 and 22.

Server 12 and browsing devices 10, 20 and are connected via a computing network, for example, through the public Internet represented by cloud 24. In some embodiments, a computing system 10 may be configured to provide information to the server 12 and browsing devices 10, 20 and 22 in response to requests from a user. As such, the server 12 may provide interfaces configured to be interacted with by a user (e.g., web pages or other browser application screens).

Each browsing device 10, 20 and 22 may be under the control of an operating system and execute or otherwise rely upon various computer software applications, components, programs, files, objects, modules, etc., consistent with embodiments of the invention. In particular, each browsing device may be configured with a data management system such as included in the iOS operating system, Internet Explorer, Firefox, Chrome, Safari, and other browsing systems, permitting the devices 10, 20 and 22 to interact with and control a database.

Each browsing device may also include peripheral devices connected through an input/output device interface. In particular, the browsing device may receive data from a user through at least one user interface (including, for example, a keyboard, mouse, a microphone, touch screen and/or other user interface) and/or output data to a user through at least one output device (including, for example, a display, speakers, a printer, and/or another output device).

In the illustrated embodiment, server 12 is configured to collect user preference information stored in memory section 16 and use it to process school statistics stored in memory section 14 and report results of this processing. It will be appreciated by one having ordinary skill in the art that the communication server 12 may include more or fewer interfaces and/or modules without departing from the scope of the invention.

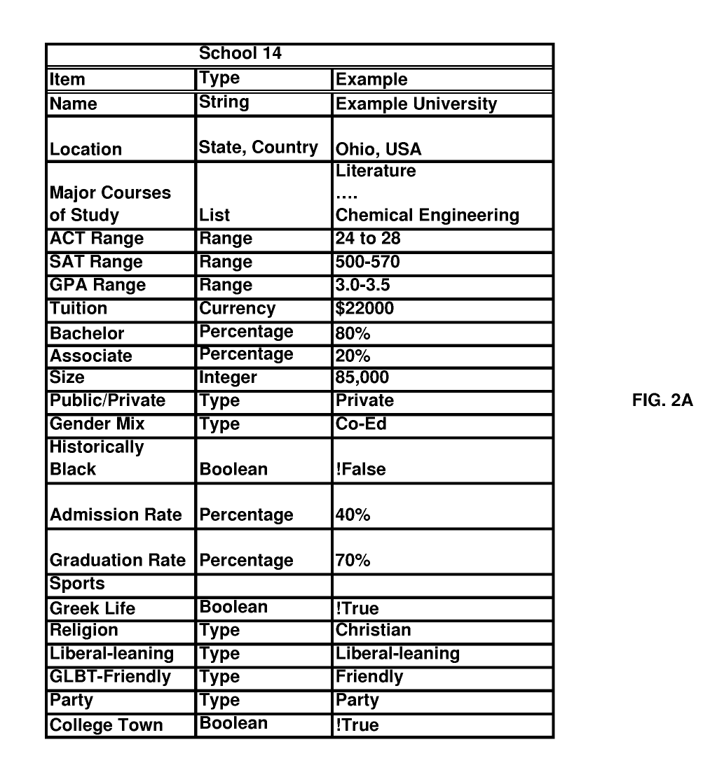

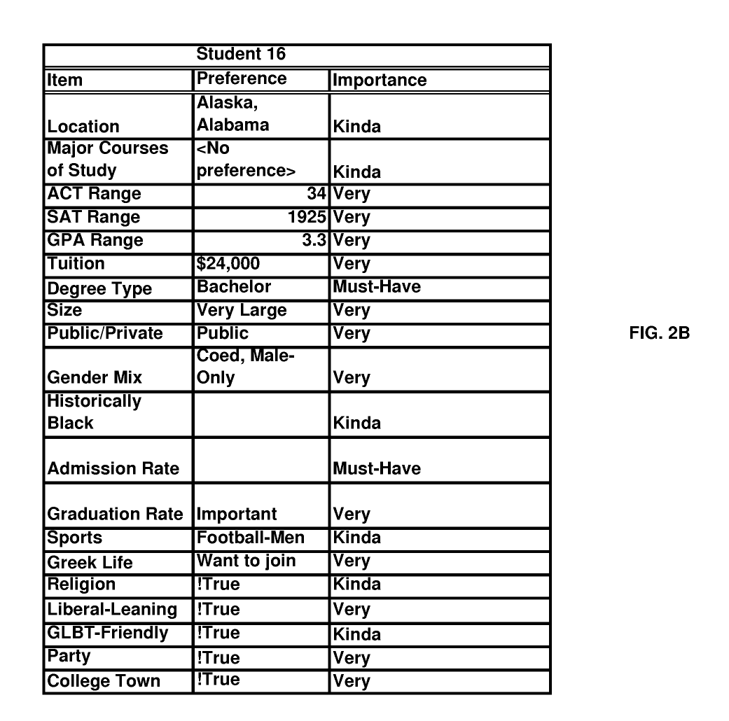

Referring now to FIGS. 2A-2B, the specific data stored in the devices and server shown in FIG. 1. This data includes records of statistics for individual schools 14, and records of individual user preferences relating to schools 16.

The school statistics include a number of items of information about a school which may be relevant to a prospective student. The specific information shown in the present application is merely exemplary, as other kinds of information and other methods for categorizing and storing that information would be known to those of skill in this art.

As seen in FIG. 2A, the information about a school includes the school name, and its location (state and country). Additionally, the major courses of study offered by the school are listed in the record. The student academic characteristics are also listed, in the form of a typical student scholastic aptitude test (SAT) score range, American College Test (ACT) score range, and high school grade point average (GPA). The annual tuition and expenses are stored, along with the percentage of degrees awarded that are Bachelor's and Associate's degrees. The size of the school (number of students) is stored, as well as the type of the school—public or private. The gender mix of the school is stored, in the form of a percentage mix of student genders, or simply as a type of male-only, female-only, and co-educational (co-ed). Also stored is whether the school is historically black, the admission rate percentage and graduation rate percentage. The sports offered by the school are provided in a list form. Finally, school social life information is characterized, by a Boolean variable “greek life” indicating whether there are on-campus fraternaties and sororities, religion, which may be a Boolean variable indicating whether the school is known for religious activity—or alternatively or in addition may identify the dominant on-campus religion. A Boolean variable is used to characterize whether the school is known to be liberal-leaning, and another Boolean variable is used to characterize whether the school campus includes resources for gay, lesbian, bisexual and transsexual (GBLT) students. Further Boolean variables indicate whether the school is reputationally a party atmosphere, and whether the school is in a well-known college town.

The above-described characterizations are stored for each of the colleges that are profiled in the system, and used for comparison to a student's/parent's preferences as identified to the system. Those preferences are separately stored in records used to build recommended colleges.

Referring now to FIG. 2B, the format of preference information can be discussed. Students express preference for school location in the form of a list of desired locations, such as, in the illustrated example, Alaska or Alabama. Students also express preferences on courses of study in the form of a list of possible majors. Students self-profile their academic credentials by way of ACT, SAT and GPA. Students further identify a desired maximum tuition, and the desired degree type. Students characterize the desired school size (small, medium, large, or very large) and preference for public or private education. Students specify a desired gender mix, and whether they desire to attend a historically black college. Students also express preference as to the selectivity of the school (in the form of types, such as “open”, “selective” and “highly selective”) and their desired statistical range for graduation rate. Students also may identify a list of on campus sports that are of interest, and specify whether the student is interested in greek life, religious activity, liberal-leaning, GLBT-friendliness, party atmosphere, and college town atmosphere.

For each criterion specified by a student or parent, the student or parent also sets an importance ranking. This ranking of importance is used in tie-breaking between schools which score similarly but on different criteria. Importance is a subjective factor that may be used to determine how particular search criteria affect rankings, and presently, importance can have one of three ranks, which are present “kinda”, “very” and “must-have”.

The present invention provides an advance upon the prior methodologies, by applying sophisticated principles in the matching of students to colleges, as follows:

1. Instead of returning a list of schools that perfectly match all search criteria, the invention rates EVERY US and Canadian school on a variable scale of 1 to 100% based upon how close they match the selected search criteria. Schools that match all criteria perfectly will score a 100% match. Schools that mismatch every search criteria by a considerable margin will score a 0% match. And of course some schools will fall in between those two extremes and will score from 1 to 99%.

2. The invention sorts the results and show the top matches, not all of which are necessarily 100% matches. In fact, it is entirely possible the user can enter criteria that is so difficult to meet that no US or Canadian schools are a 100% match. Known “hard” search tools would return no results in that case. However, the invention will return the best matches, even though non-perfect, and let the user decide how to proceed.

As can be seen, a number of the matching criteria used by the invention are Boolean values. For example, when using the Greek Life criterion, a school either has Greek social organizations or they don't. There is no middle ground, so there is no fuzzy matching on these types of criteria. Fortunately, that is not true for the majority of the search criteria available to user of the invention.

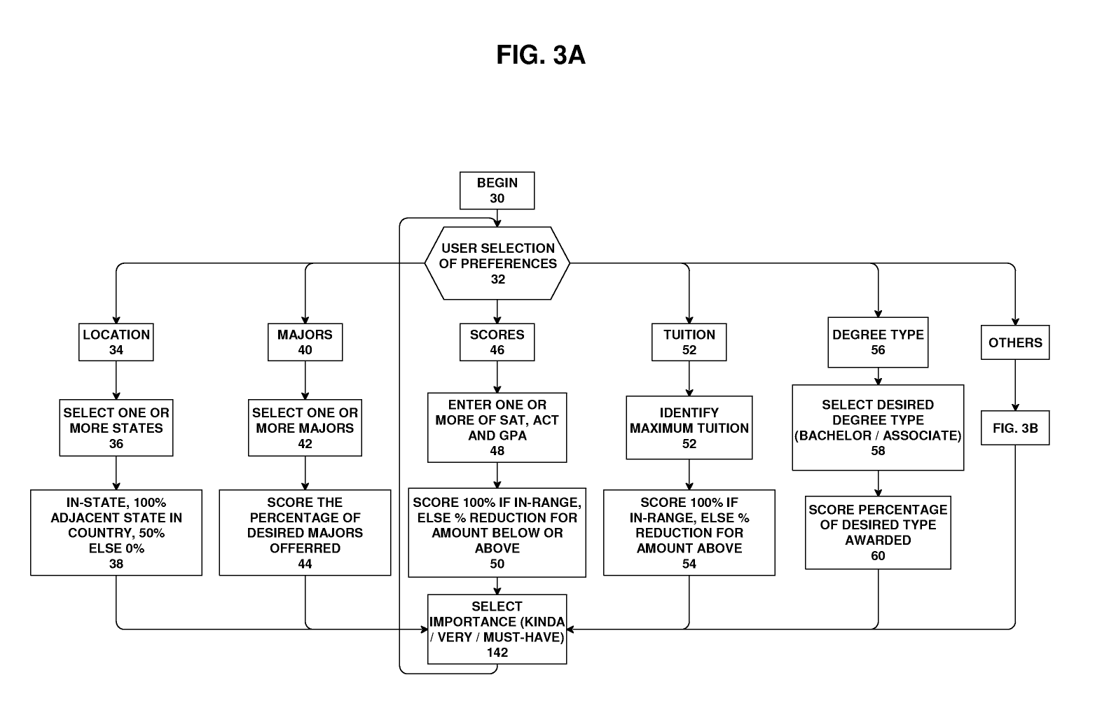

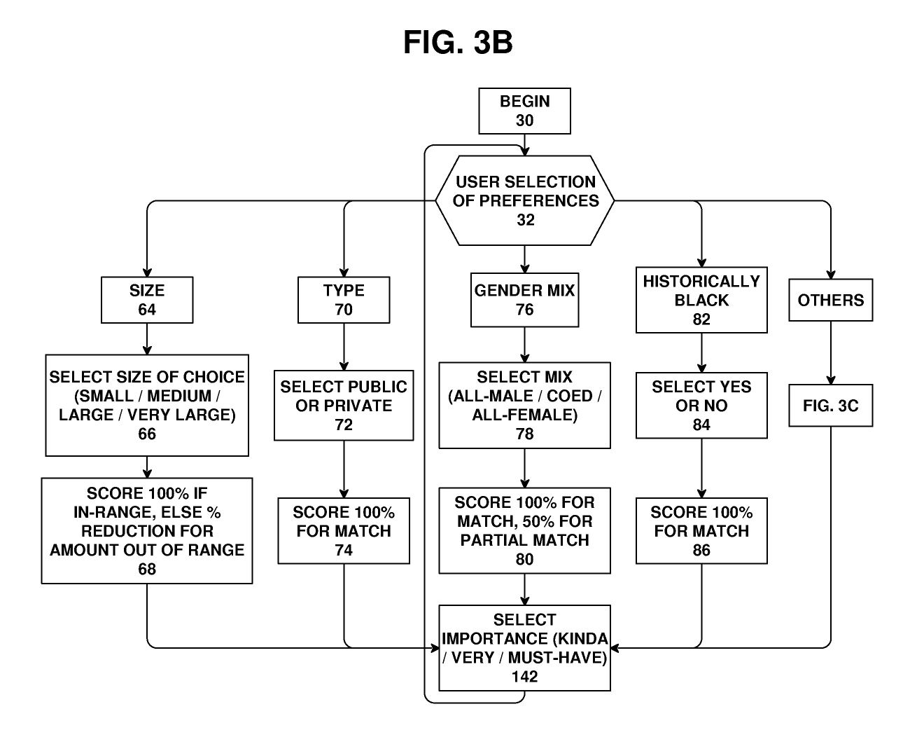

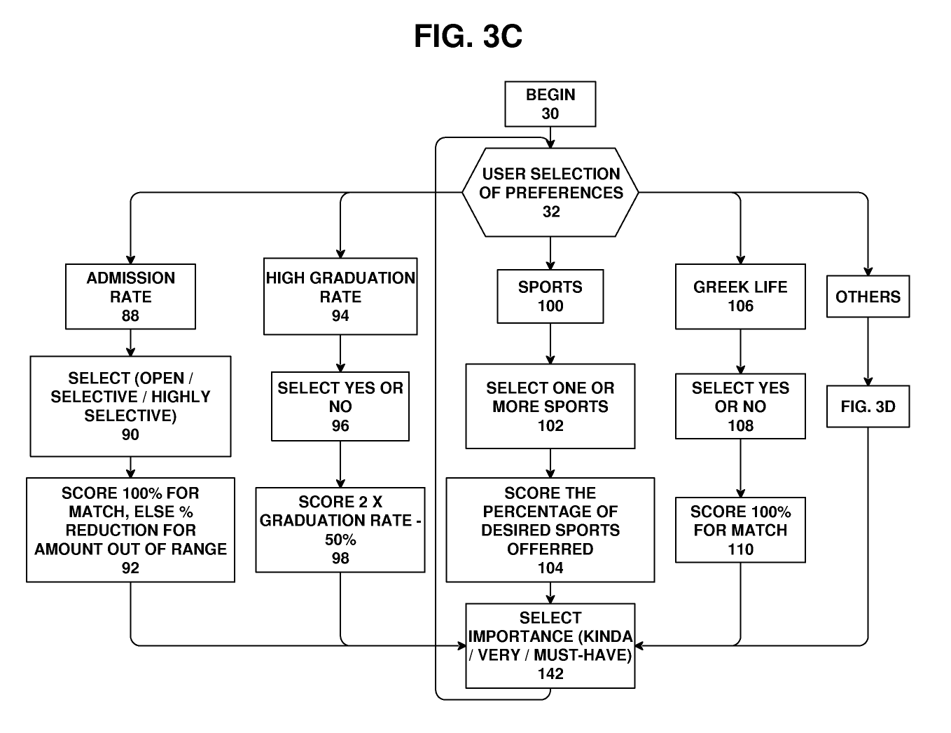

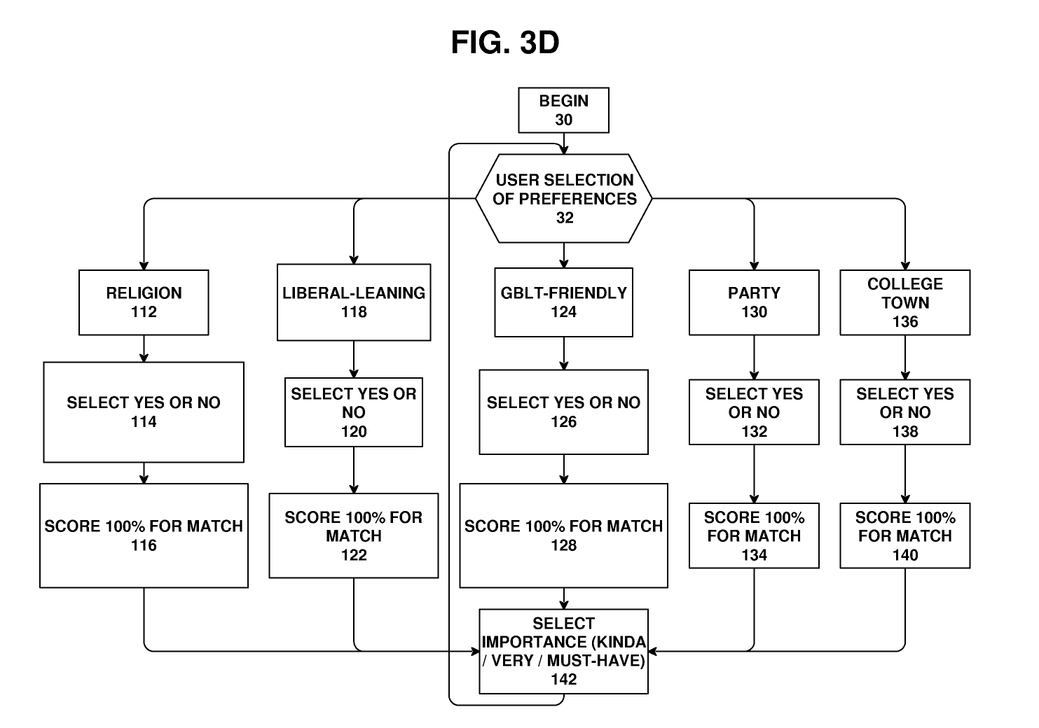

Referring now to FIGS. 3A-3D, the use of search criteria to select schools based upon school statistics, can be explained. It will be appreciated that various user interfaces may be provided for a user to select and refine school search criteria. In the embodiment illustrated in the above-referenced and incorporated provisional application, the user may choose individual criteria in any desired order, and with each criterion selected, the schools are re-scored and presented in a ranked order for consideration. Each criterion and how it is handled is discussed below with reference to the processing steps of FIGS. 3A-3D. These steps begin with the student's initiation of a school search (step 30) and the student's selection of a search criteria from a displayed list of criteria (step 32). As each criterion is selected, it is applied by the server 12 to the schools to create a ranked and scored list of the most highly ranked schools. The handling of individual criteria is reviewed below.

As seen in FIG. 3A, regarding location 34, a student identifies 36 one or more desired states and countries as a location criterion. In response (step 38), if a school is within a state/province selected by the user, the school scores a 100% match for the Location criterion. Otherwise, if a school is adjacent to a state/province selected by the user, and both the selected and school's state are in the same country, the school scores a 50% match for the Location criterion. Otherwise, the school scores a 0% match for the Location criterion.

Regarding majors 40, the student selects 42 one or more majors of interest. In response (step 44), the server 12 scores each school based on the percentage of the desired majors that are offered by the school. E.g., if the student selects 3 majors in which they are interested, and the school offers all three majors, the school scores a 100% match for the Majors criterion. Otherwise, if the school offers only two of the majors, the school score a 95% match for the Majors criterion. Otherwise, if the school offers only one of the majors, the school score a 90% match for the Majors criterion. Otherwise, the school score a 0% match for the Majors criterion.

With respect to scores 46, a student enters 48 one or more of an SAT score, ACT score and GPA, which are used for comparison and scoring 50, where the score is 100% if the student's score is within the college's typical range, and diminished from 100% based on the amount that the student's score is below the average. The inventors have worked with admissions experts to determine how wide of a range can be considered essentially equivalent for college admissions purposes, and also how far a student's score can be from the average for incoming freshmen at a typical school before they have no chance of admittance, or conversely, before reaching a point where the student is unlikely to have interest in the school. From this information, the invention utilizes a match scoring algorithm, as described below.

Consider a student with an ACT score of 26. If the school's average ACT score is in the range of 24 to 28, the school scores a 100% match for the ACT criterion. Otherwise, if the school's average ACT score is 33 or above, it is generally accepted the user has no chance of being admitted to the school, so the school scores a 0% match for the ACT criterion. Otherwise, if the school's average ACT score is between 26 and 33, the school is scored on a variable scale from 1 to 99%, with the score being less as the user's ACT score differs more from the school's average ACT score. Otherwise, if the school's average ACT score is 19 or below, we assume the user will not be interested in the school, so the school scores a 0% match for the ACT criterion. Otherwise, if the school's average ACT score is between 19 and 24, the school is scored on a variable scale from 1 to 99%, with the score being less the more the user's ACT score differs from the school's average ACT score. Similar logic is employed for SAT and GPA matching.

With respect to tuition 52, the student enters a maximum tuition 54, reflecting the amount they student can afford. Schools which are at or below this maximum are scored at 100%. Schools that have a tuition that exceeds the stated maximum by 25% or less are scored proportionate to the amount by which the maximum is exceeded. For example, if the student selects $35,000, schools having tuition and fees are in the range of $35,001 to $43,750, will score from 99% to 0% proportionate to the amount by which $35,000 is exceeded. In addition, schools that are well under the stated maximum are scored slightly less than 100%, which gives the schools closest to the user's stated maximum the “priority” when final results are sorted to determine the top matches to display in the results.

Regarding degree types 58, the user selects the desired degree type 60, typically “Bachelors” or “Associates”, which is used to score schools 62. If the user selects a 4-year degree such as “Bachelors Degree”, then schools that offer 4-year degrees will score 100%. If the school offers 2-year and 4-year degrees, then the school is scored between 0 and 80%, based upon the percentage of Bachelor degrees they offer versus Associates Degrees. Similarly, if the user selects a 2-year degree such as “Associates Degree”, a school typed as a 2-year school will score a 100% match for the Degree Type criterion. Otherwise, if the school is typed as a 4-year school, the school will be scored between 0 and 100%, based upon the percentage of Bachelor degrees the school offers as compared to Associates Degrees.

Referring now to FIG. 3B, with respect to school size 64, the student is presented with ranges of size including “Small”, “Mid-sized”, “Large” and “Very Large” and may select 66 an appropriate range. The student is permitted to select multiple contiguous choices, in which case the system combines the ranges into a larger range. The selected range is used to score 68 each school. As an example, a user selecting “Large” and “Mid-sized” schools translates to a desired range of 7,001 to 20,000 students. If a school's size is in the range of 7,001 to 20,000 students, the school is scored a 100% match for the School Size criterion. Otherwise, if the school's size is in the range of 3501 to 7,000 students, the school is scored on a variable scale from 1 to 99%, with the score being less depending on the school's size. Otherwise, if the school's size is in the range of 1 to 3500 students, the school is scored a 0% match for the School Size criterion. Otherwise, if the school's size is in the range of 20,001 to 35,000 students, the school is scored on a variable scale from 1 to 99%, with the score being less the larger the school's size. Otherwise, if the school's size is greater than 35,000 students, the school is scored a 0% match for the School Size criterion.

Regarding school type 70, the student may select 72 public or private, and if the school matches, it is given a 100% score 74 on this criterion, or else, a 0% match.

Regarding gender mix 76, the student may select 78 whether a co-ed, all-male or all-female school is desired, and this is scored 80 by awarding a school that matches the selection with 100%. Co-educational schools are awarded 50% match to a selection for all-male or all-female.

Regarding historically black status 82, the student selects 84 whether or not a school with this status is preferred, and schools matching this preference are scored 100%, others 0%.

Turning now to FIG. 3C, admission rate 88 is handled as a criterion by permitting the student to select 90 a range of selectivity, from “open” to “selective” and “very selective”. As with school size, multiple contiguous choices are allowed, in which case the system combine the ranges. Schools are scored 92 based on match to the desired selectivity. As an example, if a student selects “Very Selective” schools, a school that admits 33% of applicants or less is scored a 100% match for the admission rate criterion. Otherwise, if the school admits between 34 and 67 percent of applicants, the school is scored on a variable scale from 1 to 99%, with the score being less the more applicants the school admits. Otherwise, if the school admits more than 67 percent of applicants, the school is scored a 0% match for the criterion.

Regarding graduation rate 94, the student may indicate 96 whether a high graduation rate is an important factor, and this is used to score schools 98. If the student indicates that graduation rate is important, then schools with a graduation rate of 50% or less will score a 0% match for the Graduation Rate criterion. Otherwise, the school's percentage for this criteria is calculated using the following formula: % match=2×(graduation rate−50%), such that a school must have a 100% graduation rate to receive a 100% score in this criterion.

Regarding sports 100, the student may identify 102 one or more sports of interest, and these are used to score schools 104; a school receives a percentage score for this criterion that reflects the percentages of the desired sports that are offered by the school.

Regarding fraternity and sorority activity (aka “greek life”) 106, a student indicates whether this is important by selecting yes or no 108, and this is used to score schools 110. If the student selects “yes” for greek life, schools having on-campus fraternity and sorority activity are scored 100% for this factor, and others 0%. If the student selects “no” for greek life, then schools that lack on-campus fraternity and sorority activity are scored 100% for this factor, and others 0%.

Turning now to FIG. 3D, regarding religion 112, a student indicates whether a religiously active campus is important by selecting yes or no 114, and this is used to score schools 116. If the student selects “yes” for religion, schools having a reputation for religious activity are scored 100% for this factor, and others 0%. If the student selects “no” for religion, then schools that lack a reputation for religious activity are scored 100% for this factor, and others 0%.

Regarding political leanings 118, a student indicates whether a liberal-leaning campus is important by selecting yes or no 120, and this is used to score schools 122. If the student selects “yes” for liberal-leaning, schools having a reputation for liberal on-campus values are scored 100% for this factor, and others 0%. If the student selects “no” for liberal-leaning, then schools that lack a reputation for liberal values are scored 100% for this factor, and others 0%.

Regarding gay, lesbian, bisexual and transgender friendliness 124, a student indicates whether a GBLT-friendly campus is important by selecting yes or no 126, and this is used to score schools 128. If the student selects “yes”, schools having on-campus resources for GBLT students are scored 100% for this factor, and others 0%. If the student selects “no”, then schools that lack on-campus resources for GBLT students are scored 100% for this factor, and others 0%.

Regarding ‘party’ atmosphere 130, a student indicates whether a party atmosphere campus is important by selecting yes or no 132, and this is used to score schools 134. If the student selects “yes” for party atmosphere, schools having a reputation for party atmosphere are scored 100% for this factor, and others 0%. If the student selects “no” for party atmosphere, then schools that lack a reputation for partying are scored 100% for this factor, and others 0%.

Regarding ‘college town’ location 136, a student indicates whether a campus in a well-known college town is important by selecting yes or no 138, and this is used to score schools 140. If the student selects “yes” for ‘college town’, schools in well-regarded college towns are scored 100% for this factor, and others 0%. If the student selects “no” for college town, then schools that are not in well-regarded college towns are scored 100% for this factor, and others 0%.

The invention employs the principle of a decision matrix to the scoring of multiple search criteria to come up with one summary match percentage for each school. In simplified form, this summary match percentage is the average of the match percentage for each of the search criteria utilized. However, a unique aspect of the invention is that it allows the user to select the importance of each of those criteria to them. These importance selections then become weighting factors to be using in calculating the summary match percentage.

Specifically, after each factor is chosen, the student then selects one of three importance selections:—“Kinda” has a weighting factor of 1;—“Very” has a weighting factor of 2.1.; and, “Must Have” has a weighting factor of 50.0. (“Must have” thus acts as a “hard” criteria, in all but extreme cases preventing schools that fail to match a “must-have” criteria from appearing in the results).

The above-referenced provisional application shows exemplary search screens and a sequence of their use in a college search. In this example, a student begins the definition of a college search by specifying locations, in this case Alaska or Alabama, GPA and test scores, and a tuition range. Thereafter, the searcher defines further criteria, including the degree types, school size, public/private, and gender mix. Thereafter, to further refine the search, criteria are inserted for majors of interest (architecture related majors), and then, criteria regarding the historical black status of the college, difficulty of “getting in”, graduation rate, sports, greek life (fraternity activity on campus) religion, politics (“liberal leaning”), friendliness to gay lesbian bisexual and transsexual students, reputation for a “party scene”, and reputation as a college town. The resulting student profile is shown as an example in FIG. 2B. The introduction of each of these criteria narrows and refines the search, until ultimately, the best scoring schools are displayed, with the University of Wisconsin leading. If the candidate finds this match unappealing, then the weighting of the criteria may be changed, e.g., by changing the “location” criteria to “must have” instead of “kinda important”. Doing so changes the rankings so that Auburn University and the University of Alabama rank the most highly.

The invention includes a function “WHY?” that is presented with each highly ranked school. By selecting “WHY?”, a student may see an explanation of why the particular school is a fit to their criteria. This report will show the most positive factors for a school based on the selected criteria and the scoring method described above.

While embodiments of the present invention have been illustrated by a description of the various embodiments and the examples, and while these embodiments have been described in considerable detail, it is not the intention of the applicants to restrict or in any way limit the scope of the appended claims to such detail. Additional advantages and modifications will readily appear to those skilled in the art. Accordingly, departures may be made from such details without departing from the spirit or scope of applicants' general inventive concept.

What is claimed is:

1. A system for searching for colleges matching criteria of a searcher, comprising
storage for statistics relevant to colleges subject to the search;
storage for searcher-provided criteria for a search; and
a processor comparing stored criteria to stored statistics, the processor scoring colleges as to at least one specific criterion on a variable scale, such that a college that partially matches the specific criterion is awarded a score that is less than that awarded to a fully matching college but greater than that of a awarded to a less matched college as to the specific criterion.

2. The system of claim 1 wherein the specific criterion is location and colleges matching the location are awarded a full score, whereas colleges in neighboring locations are awarded a partial score.

3. The system of claim 1 wherein the specific criterion is available major courses of study, and a college is awarded a partial score computed based upon the percentage of the desired majors that are offered by the college.

4. The system of claim 1 wherein the specific criterion is entrance qualifying scores, and a college is awarded a partial score computed based upon the deviation of the searcher-provided scores from the score ranges of typical students of the college.

5. The system of claim 1 wherein the specific criterion is degree types, and a college is awarded a partial score computed based upon the percentage of degrees offered by the college that match the searcher's desired degree type.

6. The system of claim 1 wherein the specific criterion is size, and a college is awarded a partial score computed based upon the extent to which the college is outside of the size range stated by the searcher's criterion.

7. The system of claim 1 wherein the specific criterion is gender mix, and a college is awarded a partial score computed based upon the match of the gender mix of the college to the searcher's desired gender mix.

8. The system of claim 1 wherein the specific criterion is admission rate, and a college is awarded a partial score computed based upon the extent of mismatch between the selectivity of the college and the searcher's desired selectivity.

9. The system of claim 1 wherein the specific criterion is graduation rate, and a college is awarded a partial score computed based upon the extent of mismatch between the graduation rate of the college and a desired graduation rate.

10. The system of claim 1 wherein the specific criterion is sports, and a college is awarded a partial score computed based upon the percentage of sports desired by the searcher which are offered by the college.

11. The system of claim 1 wherein the searcher identifies an importance as to two or more criteria, and the identified importance is used as a weighting factor for scores for colleges in the two or more criteria, the weighted scores being used to rank colleges.

12. The system of claim 11 wherein the search identifies the importance using a scale of importance having at least three settings.

13. The system of claim 12 wherein the highest setting of importance causes a criterion to be weighted at least ten times more strongly than lower settings of importance.

14. The system of claim 1 wherein the stored criteria include Boolean criteria selected from the group consisting of:
public or private status of a college;
historically black status of a college;
fraternity or sorority activity at a college;
religious activity at a college;
political leanings of a college;
gay, bisexual, lesbian and transgender services at a college;
social activity reputation of a college;
reputation of the location of a college.

15. A method of searching for colleges matching criteria of a searcher, comprising
storing statistics relevant to colleges subject to the search;
storing searcher-provided criteria for a search; and
comparing in a processor, stored criteria to stored statistics, the processor scoring colleges as to at least one specific criterion on a variable scale, such that a college that partially matches the specific criterion is awarded a score that is less than that awarded to a fully matching college but greater than that of a awarded to a less matched college as to the specific criterion.

16. The method of claim 15 further comprising obtaining from the searcher an importance as to two or more criteria, the processor using the identified importance as a weighting factor for scores for colleges in the two or more criteria, the weighted scores being used to rank colleges.

17. The method of claim 16 wherein the searcher identifies the importance using a scale of importance having at least three settings.

18. The method of claim 17 wherein the highest setting of importance causes a criterion to be weighted at least ten times more strongly than lower settings of importance.

19. The method of claim 15 wherein the stored criteria include Boolean criteria selected from the group consisting of:
public or private status of a college;
historically black status of a college;
fraternity or sorority activity at a college;
religious activity at a college;
political leanings of a college;
gay, bisexual, lesbian and transgender services at a college;
social activity reputation of a college;
reputation of the location of a college.
